(19) United States
(12) Patent Application Publication
(10) Pub. No.: US 2026/0363435 A1
(43) Pub. Date: Nov. 19, 2026

(54) FITTING, PREFERABLY FURNITURE FITTING OR BUILDING FITTING

(71) Applicant: Julius Blum GmbH, Hoechst (AT)

(72) Inventors: Gerold HASENBURGER, Schwarzach (AT); Nicolas FRESSARD, Scherwiller (FR)

(21) Appl. No.: 19/740,688

(22) Filed: Jul. 14, 2026

Related U.S. Application Data
(63) Continuation of application No. PCT/AT2025/060018, filed on Jan. 23, 2025.

(30) Foreign Application Priority Data
Jan. 25, 2024 (AT) A 50051/2024

(51) Int. Cl. A47B 88/43; A47B 47/00; F16B 12/34

(52) U.S. Cl. CPC A47B 88/43; A47B 47/0083; F16B 12/34

(57) ABSTRACT

A fitting includes a base body configured to be mounted to a stationary structure, and an actuating element movable relative to the base body. The at least one actuating element is configured to be connected to a construction element that is movable relative to the stationary structure. A mounting device is arranged or configured to be arranged on the base body for mounting the base body to the stationary structure without the use of a tool. A preferably elastic securing element is configured to secure the mounting device on the stationary structure in a mounting position, and a release device is provided for moving the securing element from the mounting position into a dismounting position, the release device including a actuating element configured to be manually actuated without the use of a tool.

The present application is a continuation of International Application No. PCT/AT2025/060018, filed on Jan. 23, 2025. Thus, all of the subject matter of International Application No. PCT/AT2025/060018 is incorporated herein by reference.

### BACKGROUND OF THE INVENTION

The present invention relates to a fitting, preferably a furniture fitting or a construction fitting, the fitting comprising:
at least one base body configured to be mounted to a stationary structure,
at least one actuating element movable relative to the base body, the at least one actuating element being configured to be connected to a construction element that is movable relative to the stationary structure,
at least one mounting device arranged or configured to be arranged on the base body for mounting the at least one base body to the stationary structure without the use of a tool,
at least one, preferably elastic, securing element configured to secure the at least one mounting device on the stationary structure in a mounting position.

Moreover, the invention relates to an arrangement comprising at least one stationary structure and at least one fitting of the type to be described.

Finally, the invention concerns a method for mounting and dismounting at least one fitting of the type to be described on a stationary structure.

In recent years, a trend towards modular furniture has emerged in furniture manufacturing. This involves assembling a stationary structure in the form of a furniture carcass or in the form of a frame construction by using several individual modules, without the use of a tool. This also includes the measure to fix furniture fittings (for example drawer pull-out guides, furniture hinges or furniture drives for moving furniture flaps or furniture doors) for movably supporting a furniture part on the stationary structure without the use of a tool. In this way, it is also possible to provide a possibility for less qualified persons to attach the fitting at predetermined locations in a simple, rapid and in a positionally accurate manner. By a securing element, the fitting can be secured with respect to the stationary structure, so that a relative movement or an undesired separation between the stationary structure and the fitting can be prevented.

However, it is often desirable to dismount the fitting from the stationary structure. This may be the case, for example, when the item of furniture shall be disassembled, transported, and then reassembled due to a change in living arrangements. Dismounting the fitting is often difficult, because the securing element must be released from its mounting position with the aid of a tool. Thereby, there is a significant risk that improper use of the tool could damage the fitting, the mounting device, or another structural component, for example by causing scratches on component surfaces or on decorative surfaces, or even causing personal injury.

### SUMMARY OF THE INVENTION

It is an object of the present invention to propose a fitting of the type mentioned in the introductory part, in which dismounting of the fitting from the stationary structure is facilitated for a person.

According to the invention, at least one release device for moving the at least one securing element from the mounting position into a dismounting position is provided, the at least one release device including at least one actuating element configured to be manually actuated without the use of a tool.

In other words, at least one actuating element separate from the securing element is provided, the securing element being configured to be moved from the mounting position into a dismounting position by manually applying a force to the actuating element, without using a tool. In the dismounting position, a separation between the fitting and the stationary structure is easily possible.

The at least one securing element and the at least one actuating element can be formed together so as to have an integral one-piece configuration, and/or are connected to each other in a movement-coupled manner.

Preferably, the at least one mounting device, the at least one securing element and the at least one actuating element are formed together so as to have an integral one-piece configuration, preferably made of plastic.

### DETAILED DESCRIPTION OF THE INVENTION

Further details and advantages of the present invention will be apparent from the following description with reference to the drawings, in which:

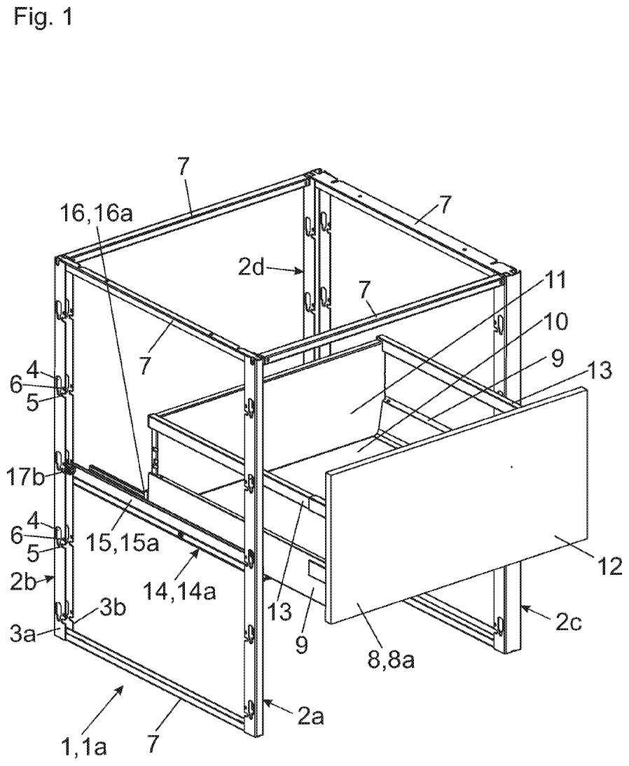

FIG. 1 is a perspective view of an item of furniture,

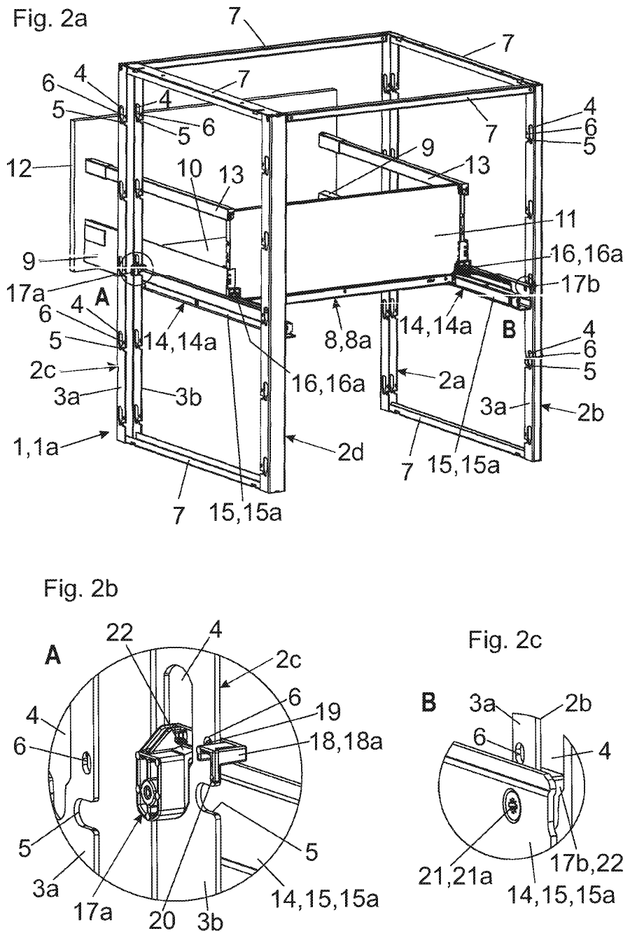

FIG. 2a-2c show the item of furniture according to FIG. 1 in a further perspective view, with two enlarged detail views thereof,

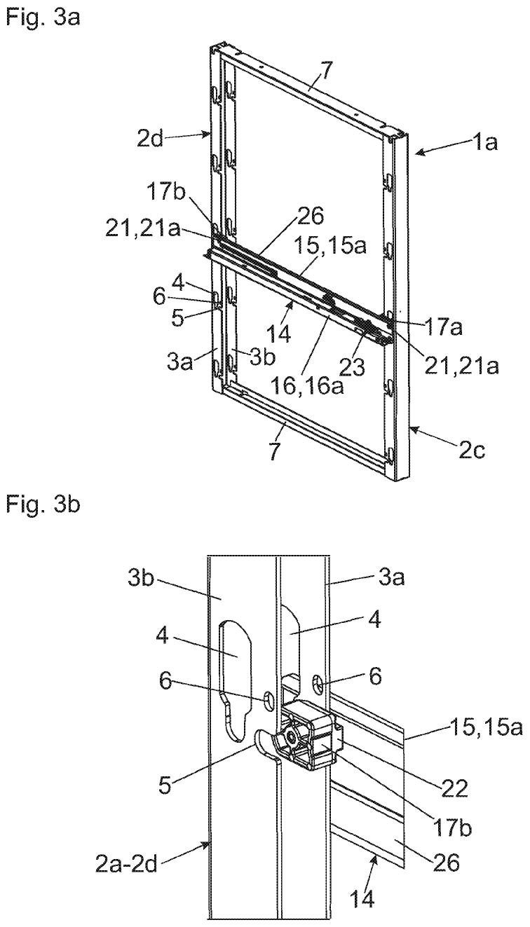

FIGS. 3a, 3b show a side portion of the stationary structure with an enlarged detail view thereof,

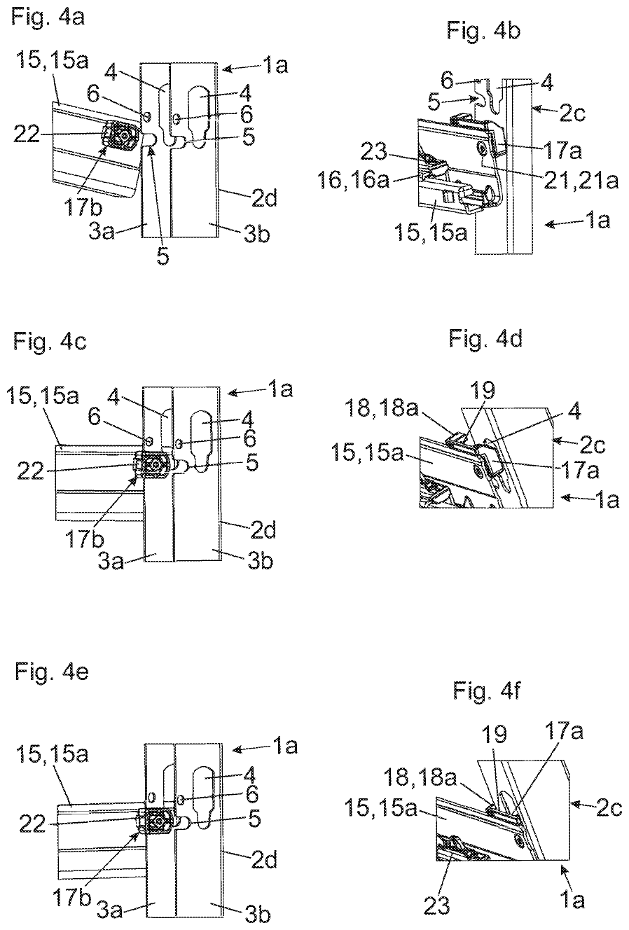

FIG. 4a-4f show the mounting operation of the base body to the stationary structure in a temporal sequence,

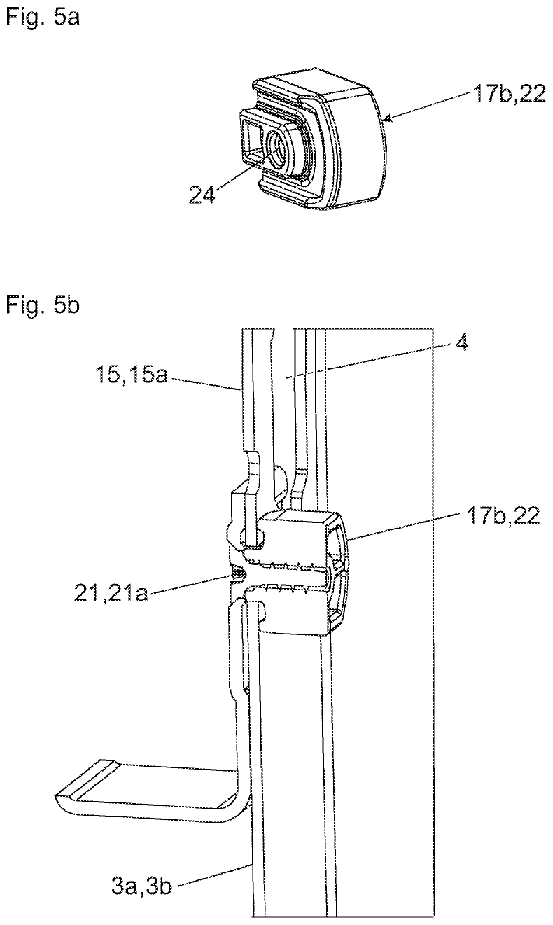

FIGS. 5a, 5b show the rear mounting device in a perspective view and in a mounted condition on the base body of the fitting, and

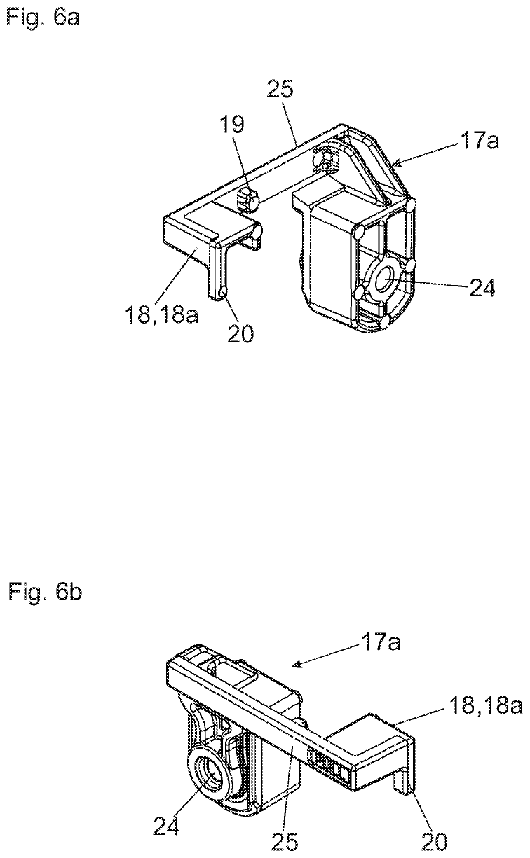

FIGS. 6a, 6b are two different perspective views of the rear mounting device.

### DETAILED DESCRIPTION OF THE INVENTION

FIG. 1 shows an item of furniture 1 in a perspective view, in which the item of furniture 1 includes a stationary structure 1a for supporting at least one construction element 8 that is movably-supported relative to the stationary structure 1a. For example, the item of furniture 1 be in the form of a base cabinet, preferably for kitchens.

In the shown embodiment, the movable construction element 8 is in the form of a drawer 8a having two drawer sidewalls 9, a drawer bottom 10, a drawer rear wall 11 and a drawer front panel 12.

For increasing the receiving capacity of the drawer 8a, at least one railing strut 13 may be provided, which extends substantially parallel to a drawer sidewall 9 and is arranged or can be arranged at a predetermined distance above the drawer sidewall 9.

However, the construction element 8 that is movable relative to the stationary structure 1a can also be a furniture flap or a furniture door.

The stationary structure 1a includes at least one vertical post 2a, 2b, 2c, 2d, preferably at least four vertical posts 2a, 2b, 2c, 2d. The at least one vertical post 2a, 2b, 2c, 2d is arranged on a corner of the stationary structure 1a.

In the shown embodiment, four vertical posts 2a, 2b, 2c, 2d are provided, the vertical posts 2a, 2b, 2c, 2d being arranged parallel to each other and being arranged on the vertical corners of a cuboid. The vertical posts 2a, 2b, 2c, 2d are connected to each other or are configured to be connected to each other, preferably without the use of a tool, by a plurality of transverse carriers 7.

On each of the vertical posts 2a, 2b, 2c, 2d, at least one fitting 14 is to be fixed. The fitting 14 includes at least one base body 15 configured to be mounted to the stationary structure 1a and at least one actuating element 16 movable relative to the base body 15.

The at least one actuating element 16 is configured to be connected to the construction element 8 that is movable relative to the stationary structure 1a.

In the shown embodiment, the fitting 14 is a drawer pull-out guide 14a comprising at least one carcass rail 15a to be fixed to the stationary structure 1a and at least one extension rail 16a displaceable relative to the carcass rail 15a. The at least one base body 15 is the at least one carcass rail 15a, and the at least one actuating element 16 is the at least one extension rail 16a.

At least one vertical post 2a, 2b, 2c, 2d, preferably all provided vertical posts 2a, 2b, 2c, 2d, includes or include at least one keyhole 4, preferably substantially vertically aligned in the mounting position, and/or at least one groove 5, preferably substantially horizontally aligned in the mounting position, and/or at least one recess 6 for fixing the base body 15 of the fitting 14.

A longitudinal direction of the at least one keyhole 4 can extend parallel to the longitudinal direction of a vertical post 2a, 2b, 2c, 2d, and/or a longitudinal direction of the at least one groove 5 can extend transversely, preferably at a right angle, to a longitudinal direction of a vertical post 2a, 2b, 2c, 2d, and/or the at least one recess 6 can be a cylindrical hole.

The at least one keyhole 4, the at least one groove 5 and the at least one recess 6 are combined to a group for fixing the base body 15 of the fitting 14. Preferably, the vertical posts 2a, 2b, 2c, 2d include two or more of such groups for fixing the fitting 14.

The fitting 14 includes at least one mounting device 17a, 17b arranged or configured to be arranged on the base body 15, and the at least one base body 15 can be mounted to the stationary structure 1a by the at least one mounting device 17a, 17b without the use of a tool.

In the shown FIG. 1, only the rear mounting device 17b can be recognized, the rear mounting device 17b being fixable to the vertical post 2b, preferably to a limb 3b of the vertical post 2b, without the use of a tool.

According to possible embodiments, the at least one vertical post 2a, 2b, 2c, 2d:
includes two limbs 3a, 3b aligned substantially parallel to each other, and/or
includes at least one U-profile having two limbs 3a, 3b aligned substantially parallel to each other. Preferably, the at least one mounting device 17a, 17b is to be fixed to a first limb 3a, 3b of the U-profile, and at least one further mounting device 17a, 17b for mounting a further base body 15 or at least one cover element (not shown) for partially covering the vertical post 2a, 2b, 2c, 2d is to be fixed to a second limb 3a, 3b of the U-profile, and/or
is made of metal, plastic, wood or of a compound material.

FIG. 2a shows the item of furniture 1 according to FIG. 1 in a perspective view from the rear, in which the vertical posts 2a, 2b, 2c, 2d of the stationary structure 1a are connected to each other via a plurality of transverse carriers 7.

The fitting 14 in the form of the drawer pull-out guide 14a includes a base body 15 in the form of a stationary carcass rail 15a, the carcass rail 15a being fixable to the stationary structure 1a via two mounting devices 17a, 17b separate from each other.

FIG. 2b shows the encircled region “A” of FIG. 2a in an enlarged view, thus a view of the front mounting device 17a on the vertical post 2c.

It can be recognized that both limbs 3a, 3b of the vertical posts 2a-2d include at least one keyhole 4, at least one groove 5, and at least one recess 6 for fixing a mounting device 17a, 17b.

The front mounting device 17a is arranged on a first end region of the base body 15 of the fitting 14. The mounting device 17a can either be firmly connected (for example welded) to the base body 15, or can be fixed to the base body 15 via at least one fastening element 21, for example a screw 21a.

At least one mounting device 17a, 17b, preferably both mounting devices 17a, 17b, can include at least one substantially mushroom-shaped portion 22 configured to be arranged or fixed in a keyhole 4, in a groove 5, or in a recess 6 of the stationary structure 1a.

At least one mounting device 17a includes at least one, preferably elastic, securing element 19 configured to secure the at least one mounting device 17a on the stationary structure 1a in a mounting position.

The at least one securing element 19 can be configured as a substantially cylindrical or conical protrusion engaging in a recess 6 of the stationary structure 1a in the mounting position.

Of course, it is also possible that the securing element 19 has a shape deviating from a cylindrical or conical shape so as to engage in the stationary structure 1a in a form-locking manner in the mounting position.

According to the invention, at least one release device 18 for moving the at least one securing element 19 from the mounting position into a dismounting position is provided, the at least one release device 18 including at least one actuating element 18a configured to be manually actuated without the use of a tool.

By manually applying a force to the actuating element 18a, the securing element 19 of the mounting device 17a is thus movable out from the corresponding recess 6 of the stationary structure 1a, so as to separate the fitting 14 from the stationary structure 1a without the use of a tool.

According to a possible embodiment, the at least one actuating element 18a can be in the form of a pivotally supported lever.

Preferably, the lever includes at least one abutment 20 for limiting a movement of the at least one lever, and the at least one abutment 20 is spaced apart from the at least one base body 15 in the mounting position of the securing element 19. In the dismounting position of the securing element 19, the abutment 20 is configured to bear against the at least one base body 15.

In the mounting position, the abutment 20 can be spaced apart from the base body 15 under the formation of a gap, and the gap can have a size of approximately 2 mm.

According to a preferred embodiment, the at least one mounting device 17a, 17b, jointly with the at least one securing element 19 and with the at least one actuating element 18a, are formed together so as to have an integral one-piece configuration made of plastic. In this way, a compact and cost-effective production of the fitting 14 can be made possible.

FIG. 2c shows the encircled region “B” of FIG. 2a in an enlarged view, thus the rear mounting device 17b on the vertical post 2b.

The rear mounting device 17b is arranged on a second end region of the base body 15 of the fitting 14. The mounting device 17b can either be firmly connected (for example welded) to the base body 15, or can be fixed to the base body 15 via at least one fastening element 21, preferably a screw 21a.

The two mounting devices 17a, 17b are arranged on the base body 15 at a distance relative to each other.

According to possible embodiments, the two mounting devices 17a, 17b are arranged on the base body 15 so as to be shifted to each other by substantially 90°, and/or are each arranged on an end region of the at least one base body 15.

To attach the fitting 14 to the stationary structure 1a without tools, the base body 15 is firstly hung onto the stationary structure 1a via the first mounting device 17b, is pivotable about an axis when hung onto the stationary structure 1a, the axis preferably extending horizontally in a mounted condition, and is subsequently fixed to the stationary structure 1a via a second mounting device 17a.

In the shown embodiment, the following steps are provided for mounting the fitting 14:
in a first step, the rear end region of the base body 15 is mounted to the stationary structure 1a without the use of a tool via the rear mounting device 17b, preferably by slightly lifting the front-end region of the base body 15 and by hanging the rear mushroom-shaped portion 22 of the rear mounting device 17b into the keyhole 4 of the vertical post 2b,
in a further step, the front-end region of the base body 15 is lowered, and the mushroom-shaped portion 22 of the front mounting device 17a is hung into the keyhole 4 of the vertical post 2c,
in a further step, the front mounting device 17a is secured to the stationary structure 1a in a mounting position via the at least one securing element 6.

For releasing the front mounting device 17a from the stationary structure 1a, the at least one securing element 19 is manually moved from the mounting position into the dismounting position via the at least one release device 18 without the use of a tool.

FIG. 3a shows a side portion of the stationary structure 1a, in which the fitting 14 is fixed to two vertical posts 2c, 2d.

Each of the vertical posts 2c, 2d includes a U-profile having two limbs 3a, 3b extending parallel to each other, the limbs 3a, 3b including a plurality of keyholes 4, a plurality of grooves 5, and a plurality of recesses 5 for fixing a mounting device 17a, 17b.

The stationary structure 1a includes at least two or more vertical posts 2a, 2b, 2c, 2d, preferably precisely four vertical posts 2a, 2b, 2c, 2d. Thereby, the at least two or more vertical posts 2a, 2b, 2c, 2d can be identical in construction or can be configured to be mirror-symmetrical to each other, and/or the two or more vertical posts 2a, 2b, 2c, 2d are connected to each other via at least one transverse carrier 7.

The fitting 14 includes at least one base body 15 in the form of a carcass rail 15a and at least one actuating element 16 in the form of an extension rail 16a displaceable relative to the base body 15. The actuating element 16 in the form of the extension rail 16a is to be connected to the construction element 8 in the form of a drawer 8a, the construction element 8 being movably supported relative to the stationary structure 1a.

By at least one coupling device 23 arranged on the actuating element 16, the construction element 8 can be coupled to the actuating element 16.

The two mounting devices 17a, 17b are arranged on both end portions of the base body 15, or can be fixed to the base body 15 via at least one fastening element 21, for example via a screw 21a.

According to a preferred embodiment, the at least one base body 15 has a side face 26 which, in a mounted condition, is aligned substantially parallel to the stationary structure 1a, and the at least one mounting device 17a, 17b is arranged on the side face 26 of the at least one base body 15.

Preferably, the side face 26 of the at least one base body 15 is configured to laterally bear against the stationary structure 1a, and/or the side face 26 of the at least one base body 15 is aligned substantially parallel to one of the two side limbs 3a, 3b of the at least one vertical post 2a, 2b, 2c, 2d.

FIG. 3b shows the region of the rear mounting device 17b on a vertical post 2a-2d. The mounting device 17b is configured to receive a substantially strip-shaped portion of the stationary structure 1a. This can be implemented, for example, by a mushroom-shaped portion 22 or by a bayonet connection.

FIG. 4a-4f show the mounting operation of the base body 15 in the form of the carcass rail 15a on the stationary structure 1a in a temporal sequence.

FIG. 4a shows the rear mounting device 17b which can be inserted into the groove 5 of the limb 3a of the vertical post 2d. For this purpose, the front end region of the base body 15 in the form of the carcass rail 15a is slightly lifted, and the limb 3a of the vertical post 2d can be partially received by the mushroom-shaped portion 22 of the mounting device 17b.

FIG. 4b shows the mounting situation of the front mounting device 17a corresponding to FIG. 4a, the mounting device 17a being connectable to the keyhole 4 of the vertical post 2c.

FIG. 4c shows that the rear mounting device 17b is pre-positioned in the groove 5 of the limb 3a of the vertical post 2d. The base body 15 in the form of the carcass rail 15a remains located in a slightly inclined position.

FIG. 4d shows the mounting situation of the mounting device 17a corresponding to FIG. 4c, in which the mounting device 17a is insertable into the keyhole 4 of the vertical post 2c.

FIG. 4e shows that the base body 15 in the form of the carcass rail 15a has been brought into a horizontal position by lowering the front end region thereof.

FIG. 4f shows the mounting situation of the front mounting device 17a corresponding to FIG. 4e, in which the mounting device 17a is now introduced in the keyhole 4 of the vertical post 2c and the securing element 19 engages into a corresponding recess 6 of the stationary structure 1a. In this way, the base body 15 is secured relative to the stationary structure 1a against an undesired relative movement.

The actuating element 18a of the release device 18 can be configured to be resilient, and the securing element 19 is movable from the mounting position into a dismounting position by a manual actuation of the actuating element 18a against the resilient action, so that the connection between the base body 15 of the fitting 14 and the stationary structure 1a can be separated.

The method for mounting and dismounting at least one fitting 14 of the type in question on a stationary structure 1a includes the following method steps:
mounting the at least one base body 15 to the stationary structure 1a via at least one mounting device 17a, 17b without the use of a tool,
securing the at least one mounting device 17a, 17b in a mounting position on the stationary structure 1a via the at least one securing element 19, and
manually moving the at least one securing element 19 via the at least one release device 18 from the mounting position into the dismounting position without the use of a tool.

FIG. 5a shows the rear mounting device 17b in a perspective view. The mounting device 17b includes at least one opening 24 for the passage of a fastening element 21, for example of a screw 21a.

FIG. 5b shows the rear mounting device 17b in a mounted condition on the base body 15 of the fitting 14. In the mounted condition of the mounting device 17b on the base body 15, a gap is formed between the base body 15 and the mounting device 17b, and a, preferably substantially strip-shaped, portion of the stationary structure 1a can be partially received within the gap.

FIG. 6a shows the front mounting device 17a in a perspective view. The mounting device 17a includes at least one opening 24 for a fastening element 21, for example for a screw 21a.

The front mounting device 17a includes at least one bracket 25 for supporting the actuating element 18a of the release device 18. The bracket 25, in the mounting position of the mounting device 17a, is aligned substantially parallel to a longitudinal direction of the base body 15 of the fitting 14.

The actuating element 18a of the release device 18 can be in the form of a pivotally supported lever, preferably having at least one abutment 20 configured to limit a movement of the lever. In the mounting position of the securing element 19, the abutment 20 is spaced apart from the at least one base body 15, and is configured to bear against the at least one base body 15 in the dismounting position of the securing element 19.

The securing element 19 can be in the form of a substantially cylindrical or conical protrusion configured to engage in a corresponding recess 6 of the stationary structure 1a in the mounting position.

FIG. 6b shows the front mounting device 17a in a further perspective view.

Although the fitting 14 has been explained with the aid of a drawer pull-out guide 14a having a carcass rail 15a and an extension rail 16a movable relative to the carcass rail 15a, it is immediately apparent that the fitting 14 can also be configured as a furniture hinge, as a furniture drive for doors or flaps, or also as a bearing device for supporting a functional unit configured to influence a movement of the construction element 8 (for example an ejection device for ejecting the construction element 8 and/or a damping device for dampening a movement of the construction element 8 relative to the stationary structure 1a).

1. A fitting, preferably a furniture fitting or a construction fitting, the fitting comprising:
at least one base body configured to be mounted to a stationary structure,
at least one actuating element movable relative to the base body, the at least one actuating element being configured to be connected to a construction element that is movable relative to the stationary structure,
at least one mounting device arranged or configured to be arranged on the base body for mounting the at least one base body to the stationary structure without the use of a tool,
at least one, preferably elastic, securing element configured to secure the at least one mounting device on the stationary structure in a mounting position,
wherein at least one release device for moving the at least one securing element from the mounting position into a dismounting position is provided, the at least one release device including at least one actuating element configured to be manually actuated without the use of a tool.

2. The fitting according to claim 1, wherein the fitting is a drawer pull-out guide comprising at least one carcass rail configured to be fixed to the stationary structure and at least one extension rail displaceable relative to the carcass rail, wherein the at least one base body is the at least one carcass rail and the at least one actuating element is the at least one extension rail.

3. The fitting according to claim 1, wherein the at least one mounting device:
includes at least one substantially mushroom-shaped portion configured to be arranged or fixed in a keyhole, in a groove, or in a recess of the stationary structure, and/or
is formed together, jointly with the at least one securing element and with the at least one actuating element, so as to have an integral one-piece configuration made of plastic.

4. The fitting according to claim 1, wherein the at least one mounting device is firmly connected to the base body or is fixed to the base body via at least one fastening element, preferably a screw, and/or wherein the at least one mounting device has an integral one-piece configuration, preferably made of plastic.

5. The fitting according to claim 1, wherein at least two mounting devices are provided, the at least two mounting devices being arranged on the base body at a distance relative to each other.

6. The fitting according to claim 5, wherein the at least two mounting devices are arranged on the base body so as to be shifted to each other by substantially 90°, and/or are each arranged on an end region of the at least one base body.

7. The fitting according to claim 1, wherein the at least one actuating element is configured as a pivotally supported lever, preferably wherein the lever includes at least one abutment for limiting a movement of the at least one lever, wherein the at least one abutment is spaced apart from the at least one base body in the mounting position of the securing element, and is configured to bear against the at least one base body in the dismounting position of the securing element.

8. The fitting according to claim 1, wherein the at least one securing element is configured as a cylindrical or as a conical protrusion engaging in a recess of the stationary structure in the mounting position.

9. The fitting according to claim 1, wherein the at least one base body has a side face which, in a mounted condition, is aligned substantially parallel to the stationary structure, wherein the at least one mounting device is arranged on the side face of the at least one base body, preferably wherein the side face of the at least one base body is configured to laterally bear against the stationary structure.

10. An arrangement comprising at least one stationary structure and at least one fitting according to claim 1, wherein the stationary structure includes at least one vertical post on which the at least one base body of the fitting is mounted or is configured to be mounted without the use of a tool via the at least one mounting device, preferably wherein the at least one vertical post:
includes at least one keyhole, preferably aligned vertically in the mounting position, for partially receiving the at least one mounting device, and/or
includes at least one groove, preferably aligned horizontally in the mounting position, for partially receiving the at least one mounting device, and/or
includes at least one recess for receiving the at least one securing element.

11. The arrangement according to claim 10, wherein the at least one vertical post:
includes two limbs aligned substantially parallel to each other, preferably wherein the side face of the at least one base body is aligned substantially parallel to at least one of the limbs of the at least one vertical post, and/or
includes at least one U-profile having two limbs aligned substantially parallel to each other, preferably wherein the at least one mounting device is to be fixed to a first limb of the U-profile, and wherein a further mounting device for mounting a further base body or at least one cover element for partially covering the vertical post is to be fixed to a second limb of the U-profile, and/or
is made of metal, plastic, wood or of a compound material.

12. The arrangement according to claim 10, wherein the stationary structure includes at least two or more vertical posts, preferably precisely four vertical posts, preferably wherein the at least two or more vertical posts are identical in construction or are configured to be mirror-symmetrical to each other, and/or wherein the two or more vertical posts are connected or are configured to be connected to each other via at least one transverse carrier.

13. The arrangement according to claim 10, wherein the stationary structure includes at least one movable construction element, preferably a drawer, wherein the movable construction element is connected or is configured to be connected to the at least one actuating element of the fitting.

14. A method for mounting and dismounting the fitting according to claim 1 on a stationary structure, the method comprising:
mounting the at least one base body to the stationary structure via at least one mounting device without the use of a tool,
securing the at least one mounting device in a mounting position on the stationary structure via the at least one securing element, and
manually moving the at least one securing element via the at least one release device from the mounting position into the dismounting position without the use of a tool.

15. The method according to claim 14, wherein the method is carried out using an arrangement including a stationary structure and the fitting, wherein the stationary structure includes at least one vertical post on which the at least one base body of the fitting is mounted or is configured to be mounted without the use of a tool via the at least one mounting device, preferably wherein the at least one vertical post:
includes at least one keyhole, preferably aligned vertically in the mounting position, for partially receiving the at least one mounting device, and/or
includes at least one groove, preferably aligned horizontally in the mounting position, for partially receiving the at least one mounting device, and/or includes at least one recess for receiving the at least one securing element.

16. The method according to claim 14, wherein the base body is firstly hung onto the stationary structure via a first mounting device, is pivotable about an axis when hung onto the stationary structure, the axis preferably extending horizontally in a mounted condition, and is subsequently fixed to the stationary structure via a second mounting device.
